(19) United States
(12) Patent Application Publication
(10) Pub. No.: US 2009/0255124 A1
(43) Pub. Date: Oct. 15, 2009

(54) Cartridge for a Shaving Razor

(76) Inventor: Hassam Hasbani, Mississauga (CA)

Correspondence Address: Elias Borges, Suite 406, 555 Burnhamthorpe Road, Toronto, ON, M9C 2Y3, CA

(21) Appl. No.: 12/101,430

(22) Filed: Apr. 11, 2008

(51) Int. Cl. B26B 21/00; B26B 21/14; B26B 21/52

(52) U.S. Cl. 30/50; 30/77; 30/527

(57) ABSTRACT

The present invention is a blade cartridge for use in a shaving razor having a handle. The blade cartridge has a housing having a front, a rear, opposite upper and lower sides and opposite first and second ends. An elongated guard is formed on the front of the housing adjacent the lower side and extends between the first and second ends. A header is formed on the housing adjacent the upper side and extends between the first and second ends. At least one blade having a cutting edge is supported in the housing between the guard and the header with the cutting edge exposed on the front and extending between the first and second ends. An elongated channel is formed on the housing between the cutting edge and the guard and extends across the housing between the first and second ends. The channel has an elongated opening which separates the cutting edge from the guard. The channel also has opposite first and second side openings formed on the first and second ends of the housing, respectively. The cartridge further includes a trimming blade having a cutting edge mounted in the header with the cutting edge exposed on the rear. Portions of the header are made of a transparent material so that portions of the header can be sufficiently see through to permit a user to see the cutting edge of the trimming blade.

### FIELD OF THE INVENTION

The invention relates generally to shaving razors.

### BACKGROUND OF THE INVENTION

Shaving razors have been around for hundreds of years. Modern day razors try to fulfill the convenience of our fast lifestyle by providing comfort, precision, and practicality. However, several problems and disadvantages still exist in most modern shaving razors. One persistent problem with most modern shaving razors is stubble and soap getting clogged between the razor blades while shaving. The accumulation of stubble and soap between the blades renders the shaving razor less effective. It is often hard to clean or shake off this accumulated debris in most modern razors. Razor designs, such as those illustrated in patents such as U.S. Pat. No. 5,918,369 to Yin et al, U.S. Pat. No. 6,182,365 to Tseng et al, U.S. Pat. No. 6,772,523 to Richard, U.S. Pat. No. 6,769,180 to Coffin and US application publication nos. 0055156 to Brown and 0144404 to Gilder all disclose a first blade (of two or more) in a front pan of the razor cartridge followed by a guard, known as the safety guard. This guard is usually a flat ridged strip placed just below the first razor blade. The space left between the guard and the first blade usually gets filed with hair, stubble and soap (debris) very quickly. This debris quickly accumulates between the rest of the blades that follow the first blade when shaving due to the narrow limited space provided in the cartridge housing be bind the razor blades. This accumulation is exacerbated by the angle of the razor blades which restrict the exit or flushing out of the debris.

Some razor designs have been developed to aid in the removal of accumulated hair, stubble and soap by means of small strips of plastic which are mounted between the razor blades and which can move forward and retract backward in to the cartridge housing with the press of a button attached to the plastic strips. By moving these plastic strips forward it pushes the accumulated debris between the razor blades out of the cartridge. While this system does work, it is not completely effective and it results in a more complicated and costly cartridge.

The other problem modern shaving razors do not solve appropriately is the outlining of hair lines, as the case in lining sideburns evenly or at the right angle, as well as the out lining of beards, goatee, and mustache. Traditionally, this task was accomplished by a straight razor which permitted the user to precisely control the cutting edge of the blade in order to trim close to the users side burns, beard, goatee or mustache. Straight razors are of course dangerous and difficult to use, and subsequently, only professional barbers tend to use them. One attempt to provide the average user with a razor capable of close precision shaving involved mounting a single blade on the rear top side of the shaving cartridge. While a trimming blade mounted in this way is useful for trimming hair of the sideburn or around the nose, it is difficult for the average user to accurately position a trimming blade which is locate on the back of a razor cartridge. The inability to accurately position the trimming blade can result in less than accurate shave. Designs have been proposed which use a light source to project a guide to assist the user in precise shaving; however, such designs are complicated to incorporate into a razor design and still due not provide the accuracy required. A shaving razor cartridge which overcomes the limitations of the prior art is therefore required.

### SUMMARY OF THE INVENTION

In accordance with one aspect of the present invention, there is provided for use in a shaving razor a blade cartridge which overcomes the disadvantages of the prior art by being easy to clean and safe to use. The blade cartridge includes a housing having a front, a rear, opposite first and second sides and opposite first and second ends with an elongated guard formed at the front of the housing adjacent the first side and extending between the first and second ends. A header is positioned adjacent the second side of the housing and extends between the first and second ends of the housing. The cartridge includes at least one blade having a cutting edge supported by the housing between the guard and the header with the cutting edge exposed on the front and extending between the first and second ends. An elongated debris flushing channel is formed on the housing between the cutting edge and the guard and extends between the first and second ends of the housing. The channel has an elongated opening which separates the cutting edge from the guard. The channel have opposite first and second side openings formed on the first and second ends, respectively.

In accordance with another aspect of the present invention, the blade cartridge described above is also provided with a trimming blade having a cutting edge supported in the header with the cutting edge of the trimming blade exposed on the rear. To make the cutting edge of the trimming blade visible by the user during use, portions of the header are made see through from the front to the rear such that the cutting edge of the trimmer blade is clearly visible through the front. Preferably, portions of the header are made from a transparent material such as transparent plastic.

In accordance with another aspect of the present invention, the flushing channel of the blade cartridge described above has an internal diameter and the side openings of the channel are flared outwardly to be wider than the internal diameter to aid in the flushing of debris accumulated in the flushing channel.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of a cartridge for a shaving razor made in accordance with the present invention and showing the cartridge mounted on a handle.

FIG. 2 is a perspective view of the cartridge shown in FIG. 1 showing the header detached from the rest of the cartridge and showing how the razor blades are inserted into the cartridge.

FIG. 3 is a front view of the front of the cartridge shown in FIG. 1.

FIG. 4 is a view of the rear of the cartridge shown in FIG. 1.

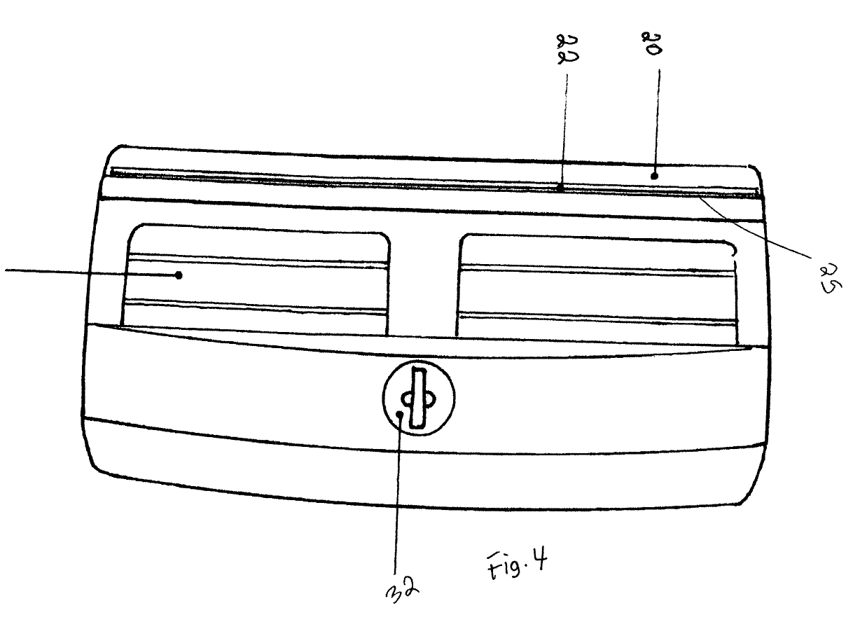

FIG. 5 is a right side view of the cartridge shown in FIG. 1.

FIG. 6 is a left side view of the cartridge shown in FIG. 1.

FIG. 7 is a top view of the cartridge shown in FIG. 1.

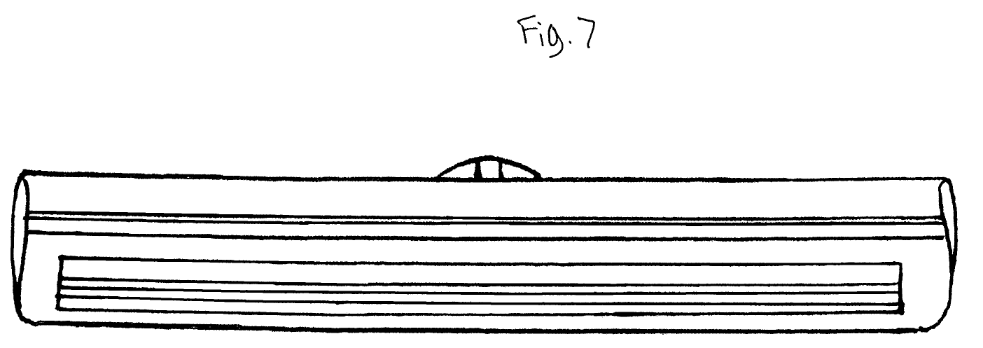

FIG. 8 is a bottom view of the cartridge shown in FIG. 1.

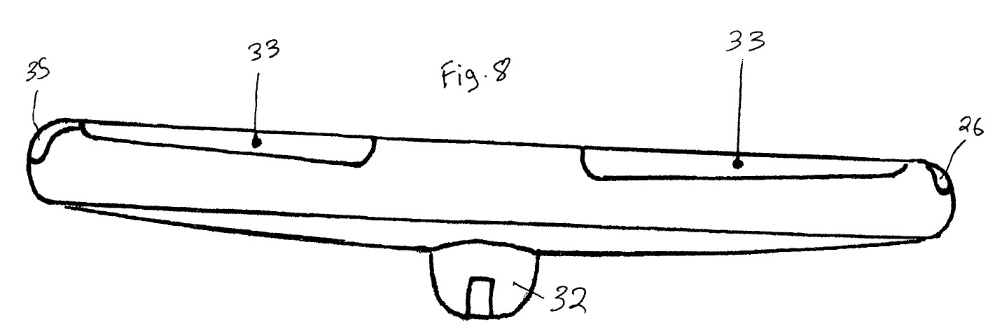

In the drawings like characters of reference indicate corresponding parts in the different figures.

### DETAILED DESCRIPTION OF THE INVENTION

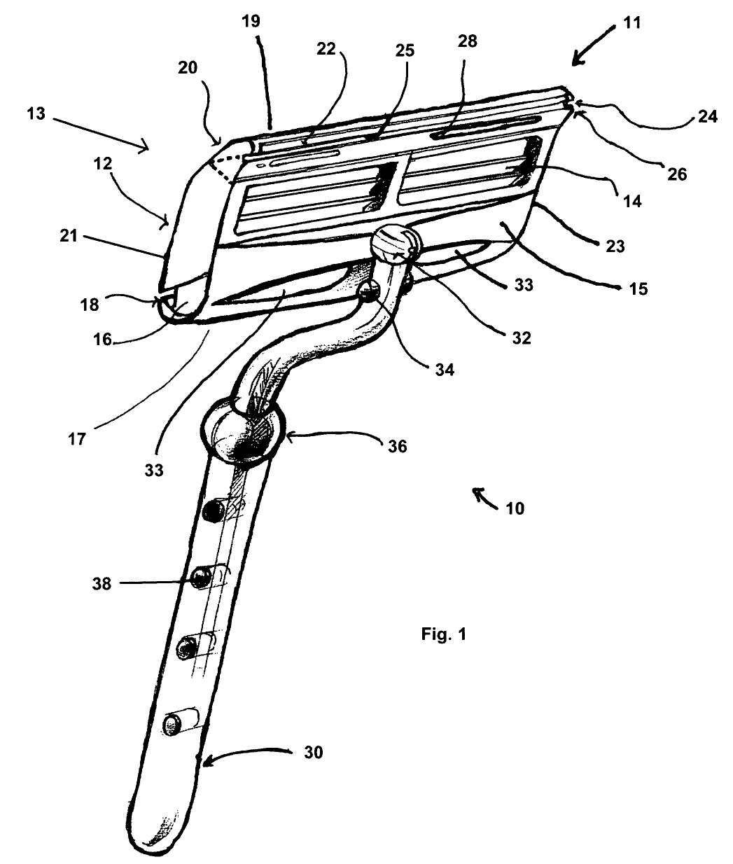

Referring firstly to FIG. 1, a shaving razor made in accordance with the present invention is shown generally as item 10 and includes a blade cartridge 9 having housing 12 housing a plurality of shaving razor blades 14. Housing 12 has a front 13 and a rear (or back) 15, a first (bottom) side 17, a second (top) side 19 and opposite first and second ends 21 and 23, respectively. Cartridge 12 has a pivotal attachment joint 32 on rear 15 adjacent bottom side 17 permitting the cartridge to be pivotally mountable to a handle 30. Cartridge 12 also has trimming header 20 on top side 19 which has trimming blade 22 with a cutting edge 25. Trimming blade 22 is mounted within header 20 such that cutting edge 25 is exposed on rear 15.

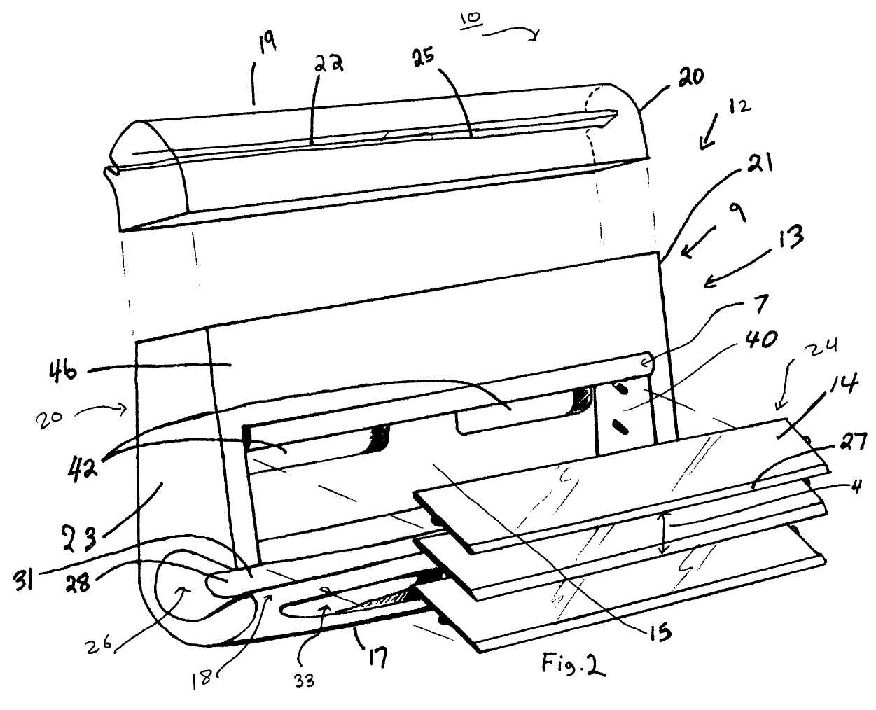

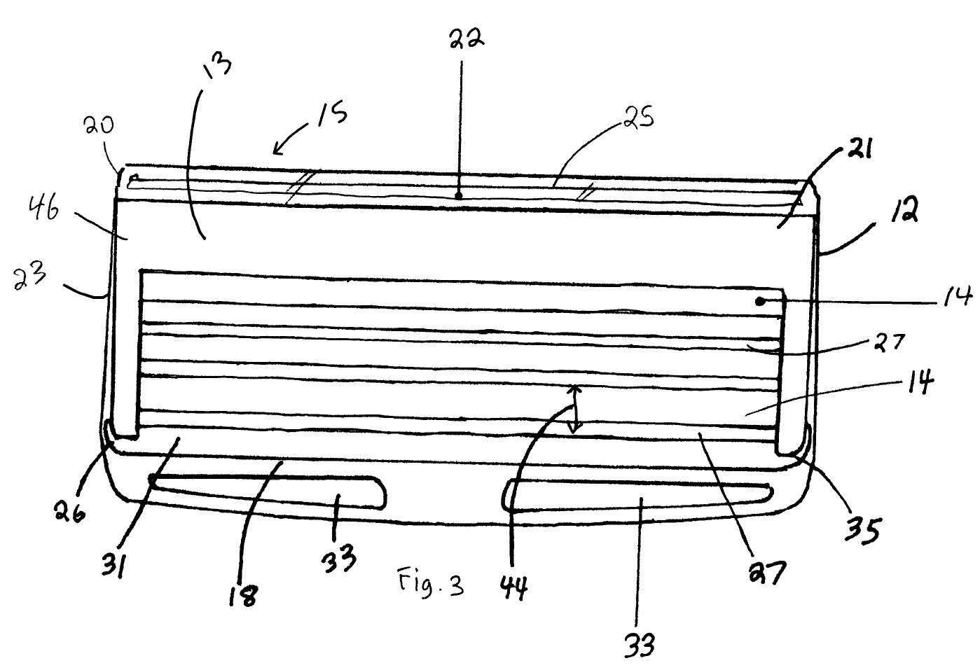

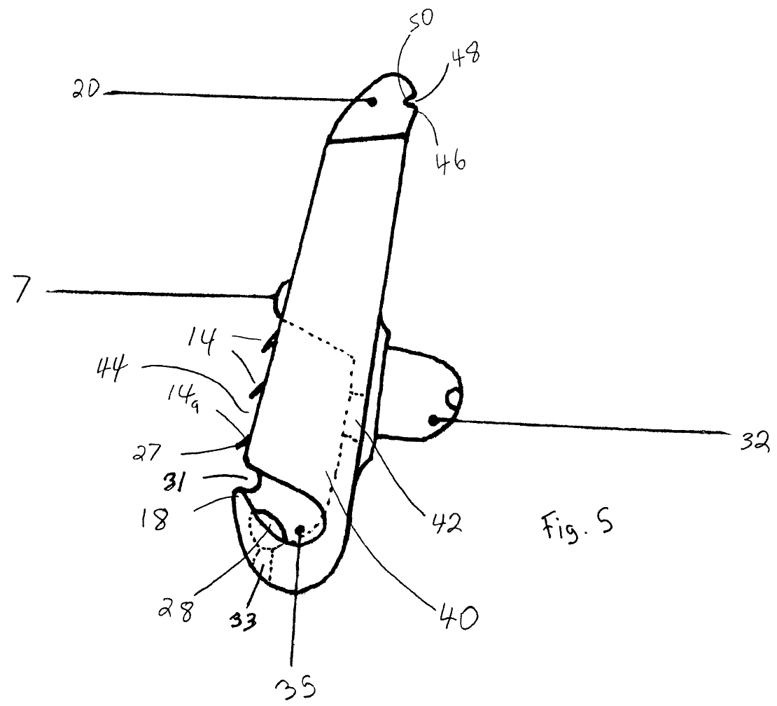

Referring now to FIG. 2, blades 14 each have cutting edges 27. Blades 14 are positioned in housing 12 such that cutting edges 27 are exposed on front 13. Guard 18 is formed on housing 12 immediately adjacent bottom side 17. An elongated channel 28 is formed on the housing between guard 18 and razors 14 and extends between ends 21 and 23. Channel 28 has longitudinal opening 31 which separates guard 18 from the cutting edge 27 of blade 14 closest to the guard. Channel 28 has flared out opening 26 formed on side 23 of the housing and a similar flared out opening 35 (see FIGS. 3 and 5) on side 21. A lubricating strip 7 may be formed on housing 12 to permit the razor to slide over the users face with less friction. A chamber 40 is formed in housing 12 to hold blades 14. Chamber 40 communicates with and as continuous with channel 28. Openings 42 are formed on rear 15 of housing 12 which communicate with chamber 40. Blades 14 are separated by gaps 44 which in turn communicate and are continuous with chamber 40 and channel 28. Housing 12 has openings 33 formed on bottom side 17 which communicate and are continuous with channel 28.

Referring now to FIGS. 2 and 3, portions of header 20 are see through from front 13 to back 15 permitting a clear view of cutting edge 25 of trimmer blade 22. Preferably, header 20 is made from a transparent material such as plastic or acrylic which is sufficiently transparent (or translucent) to permit the user to clearly see cutting edge 25 through front 15. A see through header permits the user to shave using trimmer blade 22 with confidence and precision since the user can clearly see cutting edge 25. As illustrated in FIG. 2, header 20 may be made as a separate part which is attachable to body portion 46 of the cartridge by means known generally in the art.

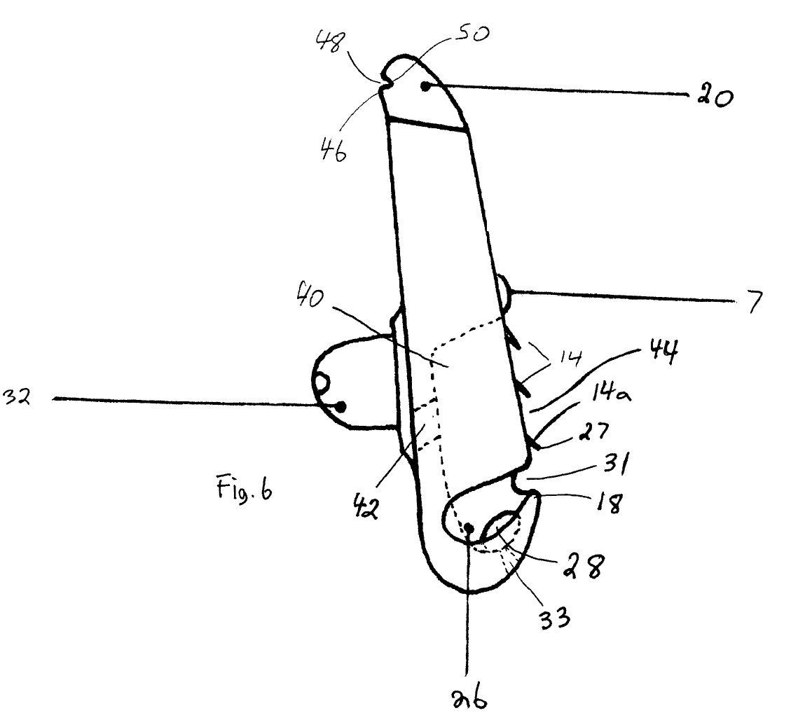

Referring now to FIGS. 5 and 6, channel 28 is continuous with side openings 26 (FIG. 6) and 35 (FIG. 5), chamber 40, gaps 44, elongated opening 31 and openings 42 and 33. During use, a majority of the accumulated debris (not shown) such as hair, stubble and soap scum scraped from the users face (not shown) will be forced by first razor blade 14a into opening 31 and then into channel 28. Channel 28 provides a means for the accumulated debris to pass into chamber 40 and then out openings 42. Openings (or ports) 33 permit a means for some of the accumulated debris to exit channel 28. The flared openings permit the users to easily flush channel 28 with water, which in turn forces any accumulated debris through chamber 40 and out openings 42 and 33. Any debris accumulated in gaps 44 between blades 14 can also be flushed away by passing water through the flared side openings of channel 28. As a result, clearing any accumulated debris from the blade cartridge is very easy achieved simply by flushing water through the flared side openings of channel 28. Header 20 may also be provided with an elongated channel 50 similar to channel 28 formed adjacent guard 46 and having elongated opening 48.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A blade cartridge of a shaving razor comprising:
a a housing having a front, a rear, opposite first and second sides and opposite first and second ends;
b an elongated guard at the front of the housing adjacent the first side and extending between the first and second ends;
c a header adjacent the second side and extending between the first and second ends;
d at least one blade having a cutting edge supported by the housing between the guard and the header with the cutting edge exposed on the front and extending between the first and second ends;
e an elongated channel extending between the first and second ends formed on the housing between the cutting edge and the guard, the channel having an elongated opening separating the cutting edge from the guard, the channel having opposite first and second side openings formed on the first and second ends, respectively.

2. The blade cartridge of claim 1 having a plurality of parallel blades.

3. The blade cartridge of claim 1 wherein the side openings are flared outwardly.

4. The blade cartridge of claim 1 wherein the at least one razor is contained in a chamber formed in the housing, the chamber communicating and being continuous with at least one aperture formed on the rear, the chamber also communicating and being continuous with the channel.

5. The blade cartridge of claim 1 further comprising a trimming blade having a cutting edge supported in the header with the cutting edge of the trimming blade exposed on the rear.

6. The blade cartridge of claim 5 wherein portions of the header are see through from the front to the rear such that the cutting edge of the trimmer blade is clearly visible through the front.

7. The blade cartridge of claim 5 wherein portions of the header are made of a transparent material.

8. The blade cartridge of claim 5 further comprising a second guard formed on the header adjacent the cutting edge of the trimming blade extending between the first and second ends and a second elongated channel extending between the first and second ends formed on the header between the cutting edge of the trimming blade and the second guard, the second channel having an elongated opening separating the cutting edge of the trimming blade from the second guard, the second channel having opposite first and second side openings formed on the first and second ends, respectively.

9. The blade cartridge of claim 8 wherein the side openings of each of the channels are flared outwardly.

10. The blade cartridge of claim 1 wherein at least one port is formed on the first side of the housing, the port communicating with the channel.

11. A shaving razor comprising a handle and a blade cartridge of claim 1.

12. The blade cartridge of claim 4 wherein at least one port is formed on the first side of the housing, the port communicating with the channel.

13. A shaving razor comprising a handle and a blade cartridge of claim 12.

14. A blade cartridge of claim 1 further comprising an attachment joint on the housing for attachment to a handle.

15. A blade cartridge of claim 14 wherein the attachment joint is on the rear of the cartridge adjacent the second side.

16. A blade cartridge of claim 5 further comprising an attachment joint for attachment to a handle, the attachment joint being on the rear of the cartridge adjacent the second side.

17. A blade cartridge of claim 8 further comprising an attachment joint for attachment to a handle, the attachment joint being on the rear of the cartridge adjacent the second side.

18. A blade cartridge of a shaving razor having a handle comprising:
a a housing having a front, a rear, opposite first and second sides, opposite first and second ends and an attachment joint on the rear adjacent the first side for attachment to the handle;
b an elongated guard formed on the front of the housing adjacent the first side and extending across the housing between the first and second ends;
c an elongated header on the second side and extending across the housing between the first and second ends;
d a plurality of elongated blades having cutting edges supported in a chamber formed in the housing between the guard and the header and extending across the housing between the first and second ends with the cutting edges exposed on the front;
e an elongated channel formed on the housing and extending across the housing between the first and second ends and between the cutting edges and the guard, the channel having an elongated opening separating the cutting edges from the guard, the channel having opposite first and second side openings formed on the first and second ends, respectively, the channel communicating with the chamber, and
f at least one opening formed on the rear of the housing communicating with the chamber.

19. The blade cartridge of claim 18 further comprising an elongated trimming blade having a cutting edge supported in the header with the cutting edge of the trimming blade exposed on the rear and extending between the first and second ends, portions of the header being sufficiently see through from the front to the rear such that the cutting edge of the trimming blade is clearly visible from the front of the housing.

20. The blade cartridge of claim 18 further comprising at least one port formed on the first side of the housing, said port communicating with the channel.
